(19) United States
(12) Patent Application Publication
(10) Pub. No.: US 2025/0132467 A1
(43) Pub. Date: Apr. 24, 2025

(54) Battery Arrangement, Method for Producing a Battery Arrangement and Motor Vehicle

(71) Applicant: Bayerische Motoren Werke Aktiengesellschaft, Muenchen (DE)

(72) Inventors: Wulf BRAMESFELD, Ginsheim-Gustavsburg (DE); Ludwig NEUMANN, Werder (DE); Oliver PRERADOVIC, Berlin (DE); Christian SCHARDAX, Garsten Nord (AT)

(21) Appl. No.: 18/685,566

(22) PCT Filed: Aug. 17, 2022
(86) PCT No.: PCT/EP2022/072897

§ 371 Date: Feb. 22, 2024

(30) Foreign Application Priority Data
Sep. 8, 2021 (DE) 10 2021 123 246.5

(51) Int. Cl. H01M 50/519; H01M 50/249; H01M 50/516; H01M 50/522; H01M 50/528

(52) U.S. Cl. CPC H01M 50/519; H01M 50/249; H01M 50/516; H01M 50/522; H01M 50/528; H01M 2220/20

(57) ABSTRACT

A battery arrangement comprising a large number or plurality of energy storage cells, wherein the energy storage cells have connection poles to which cell connectors are fastened, in particular welded, for interconnecting the energy storage cells. The energy storage cells are connected to a contact-making system which is formed by a printed circuit board having a covering layer on both sides, wherein the printed circuit board is arranged between the connection poles and the cell connectors in such a way that the fastening points, in particular the welding points, by way of which the cell connectors are indirectly connected to the connection poles via the printed circuit board are protected against external influences by the covering layers.

### BACKGROUND AND SUMMARY

The present disclosure relates to: a battery arrangement, such as a battery module, a method for producing a battery arrangement and, a motor vehicle.

Battery arrangements of the type in question comprise a large number of electrical energy storage cells, such as round cells or prismatic cells, which are electrically interconnected to one another to form an energy store, such as a high-voltage battery. The energy storage cells must be monitored during operation, for example, by recording the electrical voltage and the temperature of the cells. A cable harness which is connected to the energy storage cells may be used for this purpose. A support plate which is arranged on the energy storage cells is often used. The cable harness is integrated in such support plates. Also arranged in the support plate are the cell connectors, which serve for connection to the connection terminals/poles of the energy storage cells. The arrangement or fastening of the various components/elements against/to one another is not unproblematic, since different materials are connected to one another and corrosion problems can occur. The cell connectors are for example made of aluminum, while the aforementioned cable harness and/or signal lines are made of copper. This problem is also addressed in DE 10 2018 298 340 A1. The laid-open application relates to cell contacting for an energy storage module which comprises at least one energy storage cell, each storage cell having at least two connection terminals, the cell contacting comprising a support plate, which can be arranged on the energy storage module, a cable harness, which is supported by the support plate and has multiple signal lines, and multiple cell connectors, which are inserted in the support plate or integrated in the support plate and are designed to connect a connection terminal of the storage cell and a signal line of the cable harness, with a connecting element being provided, having a first end, which can be connected via signal lines, and a second end, which can be connected to the cell connector, the support plate and/or the cell connectors having at least one spatial orientation element, which establishes the spatial orientation between the connecting element and the cell connector and/or support plate. The additional connecting element and the orientation element allow a quick, easy, and exact locational arrangement to be achieved between the signal line and the cell connector. However, at the same time the installation and assembly effort also increases.

It is therefore an object of the present disclosure to provide a battery arrangement, a method for producing a battery arrangement, and a motor vehicle that are of a simple and low-cost construction, and at the same time, meet the highest requirements with regard to corrosion protection.

According to the disclosure, the battery arrangement comprises a large number or plurality of energy storage cells, the energy storage cells having connection poles to which cell connectors are fastened, in particular by material bonding, such as welding, for interconnecting the energy storage cells, whereby fastening points/welding points are formed, and the energy storage cells being connected to a contacting system, which is formed by a printed circuit board having a covering layer of both sides, the printed circuit board being arranged between the connection poles and the cell connectors in such a way that the fastening points, in particular the welding points, by way of which the cell connectors are indirectly connected to the connection poles by way of the printed circuit board, are protected from external influences by the covering layers. The energy storage cells each comprise two connection poles, a positive pole and a negative pole. The energy storage cells are not restricted to a specific structural form. Typical structural forms are, for example, round cells or prismatic cells. By way of the connection poles and the cell connectors, the energy storage cells are electrically interconnected, for example in series. The contacting system is intended and designed to record, among other things, the voltage of the cells, in other words, is designed to make monitoring of the energy storage cells possible. The contacting system is in particular expediently designed to record the temperatures of the individual energy storage cells. In the present case, voltage taps and the functionality provided for temperature recording are expediently integrated in the printed circuit board.

The printed circuit board, also known as a board or printed circuit, is a support for electronic components. It serves for mechanical fastening and electrical connection. The printed circuit board expediently comprises a support or a support material, which comprises conductor tracks for contacting and connecting the energy storage cells, sensors etc. For insulating the printed circuit board, covering layers are expediently provided respectively on the upper side and underside, or are formed directly by the support material. In the present case, these insulating or covering layers expediently serve or are used for protecting the fastening points, or in particular the welding points, from corrosion. The arrangement expediently takes place in such a way that a printed circuit board rests on one connection pole and the respective cell connector is indirectly fastened to the corresponding connection pole by way of the printed circuit board, in particular via welding. By this arrangement, the fastening point/welding point is automatically integrated by way of the covering layers. In other words, the fastening point is embedded in the covering layers, or is bordered or ringed by them.

The covering layers are expediently formed from a plastic which acts as an insulating layer. These covering layers are advantageously part of the printed circuit board in any case, so that it is possible to dispense with separate corrosion protection. The arrangement of the printed circuit board between the connection poles and the cell connectors has the effect that insulation of the fastening points is automatically achieved or brought about.

According to one embodiment, the printed circuit board has a support made of an electrical insulating material with conducting connections (conductor tracks) bonding to it. The electrically insulating material may be a plastic.

According to a preferred embodiment, the printed circuit board is in the present case a flexible printed circuit board (FPC). It has been found that, with flexible printed circuits, complex cell connecting systems can be created very quickly and cost-effectively. This may, for example, involve using etched copper-coated films, for example, polyimide films, which represent the aforementioned support material. In the present case, single-sided FPCs, double-sided FPCs, or multi-layer FPCs may be used.

According to a preferred embodiment, the flexible printed circuit board has on the outside polyimide layers which are respectively connected by way of adhesive layers to a conductor track or conductor tracks formed in between or in the middle. The outer polyimide layers, possibly also together with the respective adhesive layers, are in the present case referred to as the covering layers. Depending on the configuration, single-sided or multi-layer flexible printed circuit boards may be advantageously used.

The connection poles expediently have first contact areas, which indirectly contact second contact areas of the cell connectors by way of the printed circuit board. The indirect contacting expediently takes place in this case by way of the conductor tracks or by way of the conductor track of the printed circuit board arranged there.

According to one embodiment, in the region of the contact area/contact areas or at least in the region of the fastening point/fastening points, the covering layers or at least one covering layer have/has been removed or are/is not present. In other words, the printed circuit board is correspondingly “exposed” in the region of the contact areas in order not to cause any adverse effects on the welding result by melting of the covering layers.

According to one embodiment, the contact areas contact the covering layers, at least in some regions. The covering layers are therefore, at least partially, arranged between the contact areas. The fastening point or welding point itself expediently does not have covering layers for the aforementioned reasons. Alternatively, the covering layers may however also be initially formed as permeable in the region of the fastening points if it is ensured that the covering layers do not influence the welding result. In other words, the covering layers are then welded over. This may possibly be advantageous, since the covering layers do not have to be removed or the corresponding points do not have to be left free. Furthermore, in this way dependable embedding of the fastening points is also ensured.

According to one embodiment, the covering layers or at least one covering layer at least adjoin the contact areas. Adjoining should be understood as meaning that it is ensured that the fastening points are dependably protected from external influences.

According to a preferred embodiment, the cell connectors are fastened to the connection poles via fusion or pressure welding. Preferred welding methods are in the present case laser welding or ultrasonic welding.

According to a preferred embodiment, the connection poles and the cell connectors are formed from an aluminum material. The conductor tracks of the printed circuit board are typically made of a copper material. Any corrosion problems at the fastening points can be advantageously avoided by the insulation of the covering elements or the embedding of the fastening points in the covering layers. In addition, the battery arrangement is distinguished by its simple construction, since the printed circuit board allows even complicated interconnecting structures to be created well by machine. The cell connectors that serve for interconnecting the cells are placed onto the printed circuit board at the desired points and are then indirectly welded to the connection poles by way of the printed circuit board.

The disclosure is also directed to a method for producing a battery arrangement, comprising the steps of: arranging a large number or plurality of energy storage cells for forming a battery arrangement; arranging on the battery arrangement a printed circuit board which is designed to form the contacting system of the battery arrangement, the conductor tracks of the printed circuit board contacting corresponding connection poles of the energy storage cells and the printed circuit board having covering layers on both sides; and, interconnecting the energy storage cells by the fastening of cell connectors to the connection poles, the cell connectors being indirectly fastened to the connection poles by way of the printed circuit board, whereby the fastening points are protected from external influences by way of the covering layers.

The advantages and features mentioned in connection with the battery arrangement apply analogously and correspondingly to the method, and vice versa.

In the present case, the cell connectors are advantageously not fastened to the connection poles directly, but indirectly by way of the printed circuit board. In this way, the outer layers of the printed circuit board, which may also be referred to as covering layers or insulating layers, can be used for insulating or embedding the fastening points. The covering layers or insulating layers are preferably formed from a plastics material. In the case of the use of a flexible printed circuit board, it is typically a polyimide material. The entire construction and also the method are distinguished by their simplicity. Moreover, low weights can be achieved. In spite of the simple construction, a very long service life is ensured, since the construction is accompanied by outstanding corrosion protection.

The disclosure is also directed to a motor vehicle, comprising at least one battery arrangement according to the disclosure. Preferred motor vehicles are in particular land vehicles, such as passenger cars, motorcycles and commercial vehicles. Battery arrangements of the type in question are expediently arranged or accommodated in an energy storage housing. According to one embodiment, such energy storage housings have a lower housing part and an upper housing part, it being possible for one or more battery arrangements to be arranged in the lower housing part.

According to one embodiment, an energy store has multiple battery arrangements. Such battery arrangements may also be referred to as battery modules. Alternatively, it is also possible for only one, in this case very large, battery module to be provided. This is typically the case when using round cells as energy storage cells.

### BRIEF DESCRIPTION OF THE DRAWINGS

Further advantages and features emerge from the following description of embodiments of battery arrangements with reference to the appended figures, in which:

FIG. 1 shows a schematic partial view of an embodiment of a battery arrangement;

FIG. 2 shows a further schematic partial view of an embodiment of a battery arrangement; and,

FIG. 3 shows a further schematic representation of an embodiment of a battery arrangement.

### DETAILED DESCRIPTION OF THE DRAWINGS

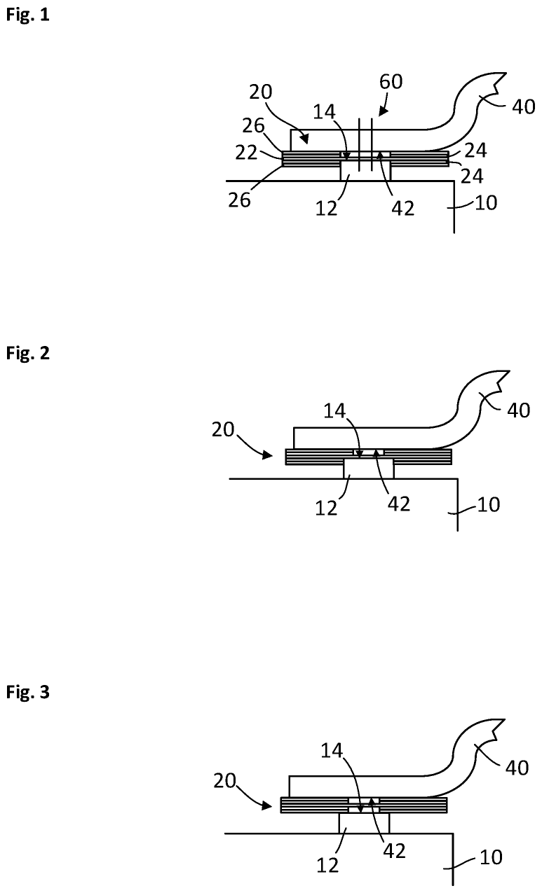

FIG. 1 shows a detail of a battery arrangement in a schematic view. The region of an energy storage cell 10 along with a connection pole 12 can be seen. This is for example an energy storage cell 10 with a prismatic housing. The second connection pole is not shown in the present case. Reference sign 40 denotes part of a cell connector, which is welded to the connection pole 12 by way of two welding points 60, for example two laser welding seams. The connection pole 12 has a first contact area 14, the cell connector 40 has a second contact area 42. These do not directly adjoin one another. Arranged in between is a printed circuit board 20, which comprises outer covering layers 26, which are connected by way of adhesive layers 24 to a conductor track 22. It is schematically shown that the contact areas 14 and 42, and in particular, the fastening points 60, are insulated, encapsulated, and shielded from external influences all around by way of the covering layers 26. The outer layers 26, as schematically depicted in FIG. 1, are in particular plastic layers, for example polyimide layers, which take the form of a flexible printed circuit board. It should be noted that the present diagram does not give a true representation of the relative sizes. For instance, in reality, there is no gap between the second contact area 42 and the conductor track 22.

In the embodiment shown in FIG. 1, the covering layers 26 adjoin the contact areas 14 and 42. This arrangement is used to achieve embedding or surrounding of the contact areas, and consequently also of the fastening points. The printed circuit board has been freed of the insulation or the outer covering layers in the region of the contact areas 14 and 42, whereby it can be achieved that only metal on metal is welded. Any outer polyimide layers therefore do not influence the welding result.

In FIG. 2, an embodiment which is substantially similar to that known from FIG. 1 can be seen. However, the outer layers of the printed circuit board 20 reach into the region of the first contact area 42. Otherwise, the features are known from FIG. 1.

FIG. 3 shows an embodiment in which the outer layers of the printed circuit board 20 project both into the region of the first contact area 42 and into the region of the second contact area 14.

In both cases, that is to say, both according to the embodiment of FIG. 2 and also the embodiment of FIG. 3, metal can be welded onto metal.

It is also alternatively possible that, in the region of the contact areas 14 and 42, the covering layers are also in each case formed continuously, that is to say, on the upper side and underside. Here it must however be checked whether the welding result is possibly adversely influenced.

### LIST OF REFERENCE SIGNS

10 Energy storage cell
12 Connection pole
14 First contact area
20 Printed circuit board
22 Conductor track
24 Adhesive layer
26 Covering layer
40 Cell connector
42 Second contact area
60 Welding point, fastening point

1.-11. (canceled)

12. A battery arrangement comprising:
a plurality of energy storage cells,
the energy storage cells having connection poles, to which cell connectors are fastened, for interconnecting the energy storage cells, whereby fastening points are formed, and
the energy storage cells being connected to a contacting system, which is formed by a printed circuit board having a covering layer on both sides,
the printed circuit board being arranged between the connection poles and the cell connectors in such a way that the fastening points, by way of which the cell connectors are indirectly connected to the connection poles by way of the printed circuit board, are protected from external influences by the covering layers.

13. The battery arrangement of claim 12,
wherein the covering layers are formed from a plastic which acts as an insulating layer.

14. The battery arrangement of claim 12,
wherein the printed circuit board is a flexible printed circuit board.

15. The battery arrangement of claim 12,
wherein the connection poles have first contact areas, which indirectly contact second contact areas of the cell connectors by way of the printed circuit board.

16. The battery arrangement of claim 15,
wherein, in the region of the contact areas, or at least in the region of the fastening points/welding points, the covering layers have been removed or are not present.

17. The battery arrangement of claim 15,
wherein the contact areas contact the covering layers, at least in some regions.

18. The battery arrangement of claim 15,
wherein the covering layers at least adjoin the contact areas.

19. The battery arrangement of claim 12,
wherein the cell connectors are fastened to the connection poles via fusion or pressure welding.

20. The battery arrangement of claim 12,
wherein the connection poles and the cell connectors are formed from an aluminum material.

21. A method for producing a battery arrangement, comprising the steps of:
arranging a plurality of energy storage cells for forming a battery arrangement;
arranging on the battery arrangement a printed circuit board which is designed to form the contacting system of the battery arrangement, conductor tracks of the printed circuit board contacting corresponding connection poles of the energy storage cells, and the printed circuit board having covering layers on both sides;
interconnecting the energy storage cells by the fastening of cell connectors to the connection poles, the cell connectors being indirectly fastened to the connection poles by way of the printed circuit board, whereby the fastening points are protected from external influences by way of the covering layers.

22. A motor vehicle, comprising at least one battery arrangement of claim 12.
